(19) United States
(12) Patent Application Publication
(10) Pub. No.: US 2010/0092802 A1
(43) Pub. Date: Apr. 15, 2010

(54) MULTI-STEP ETCH PROCESS FOR GRANULAR MEDIA

(75) Inventors: Xiaoding Ma, Fremont, CA (US); Jing Gui, Fremont, CA (US); Michael Joseph Stirniman, Fremont, CA (US); Thomas Nolan, Fremont, CA (US)

Correspondence Address: Seagate Technology LLC, 920 Disc Drive, Scotts Valley, CA, 95066, US

(73) Assignee: Seagate Technology LLC, Scotts Valley, CA (US)

(21) Appl. No.: 12/252,022

(22) Filed: Oct. 15, 2008

(51) Int. Cl. G11B 5/62; C23F 1/02

(52) U.S. Cl. 428/800; 204/192.34

(57) ABSTRACT

A method of forming a granular magnetic recording medium comprises etching a cap layer disposed on a granular magnetic recording layer. The etching process is carried out at a varying ion energy, including a first ion energy and a lower subsequent second energy. A device including the etched cap layer is also disclosed.

### BACKGROUND

Granular media, that includes at least one granular layer, may be used for a variety of different applications. The granular layer includes grains that may include grain cores of a continuous density with more porous and/or less dense grain boundaries. Such granular media can be used, among other applications, for optical, solar cell, semiconductor or magnetic film applications. Methods that are employed to make such granular media may include, but are not limited to, sputtering, for example high pressure sputtering, reactive sputtering and sputtering of targets with oxide materials. In many instances it is advantageous to protect the granular media from environmental influences and/or corrosion. However, it has been found that a simple protective overcoat deposited on the granular layer may be ineffective at protecting the media.

For example, granular magnetic media are widely used in various applications, particularly in the computer industry for data information storage and retrieval applications, preferably in disk form, and efforts are continually made with the aim of increasing the areal recording density, i.e., bit density of the magnetic media. Thin-film type magnetic media, wherein a fine-grained polycrystalline magnetic alloy layer serves as the active recording layer, are generally classified as “longitudinal” or “perpendicular”, depending upon the orientation of the magnetic domains of the grains of magnetic material. In perpendicular magnetic recording media, residual magnetization is formed in a direction perpendicular to the surface of the magnetic medium, a layer of a magnetic material on a suitable substrate. High linear recording densities are obtainable by utilizing a “single-pole” magnetic transducer or “head” with such perpendicular magnetic media.

Magnetic recording media with granular magnetic recording layers possess great potential for achieving ultra-high areal recording densities. One methodology for manufacturing granular-type magnetic recording media involves reactive sputtering of the magnetic recording layer in a reactive gas-containing atmosphere, e.g., an 0₂ and/or N₂ atmosphere, in order to incorporate oxides and/or nitrides therein and achieve smaller and more isolated magnetic grains. However, magnetic films formed according to such methodology are frequently porous and rough-surfaced compared to media formed utilizing other techniques as a result of the high pressure, low temperature or reactive techniques used to form the films. Corrosion and environmental testing of granular recording media indicate poor resistance to corrosion and environmental influences. Even relatively thick carbon-based protective overcoats, e.g., ˜40 Å thick, provide inadequate resistance to corrosion and environmental attack. Studies have determined that a root cause of the poor corrosion performance of granular magnetic recording media is incomplete coverage of the surface of the magnetic recording layer by the protective overcoat (preferably carbon), due to high nano-scale roughness, porous oxide grain boundaries, and/or poor carbon adhesion to oxides.

### SUMMARY

The disclosed method includes manufacturing granular media and etching a cap layer disposed over a granular layer. The method includes providing a substrate with a layer stack disposed thereon. The layer stack includes an outermost granular layer. A cap layer is disposed on the outermost granular layer. An etching process is carried out on an outer surface of the cap layer. The etching process includes ion etching carried out at a varying set ion energy over a duration of time. The set ion energy includes a first ion energy when the cap layer is thick and a second ion energy when the cap layer is thinner.

Also disclosed is granular magnetic recording medium including a non-magnetic substrate, a layer stack on said substrate, a cap layer on the layer stack and a protective overcoat layer. The layer stack includes an outermost granular magnetic recording layer free of sputtered Ar atoms. Additionally, the cap layer has a sputter etched outer surface.

These and various other features and advantages will be apparent from a reading of the following detailed description

### BRIEF DESCRIPTION OF THE DRAWINGS

The following detailed description of the embodiments of the present disclosure can best be understood when read in conjunction with the following drawings, in which the various features (e.g., layers) are not necessarily drawn to scale but rather are drawn as to best illustrate the pertinent features, wherein:

FIG. 1 schematically illustrates, in simplified cross-sectional view, a portion of a thin film longitudinal magnetic recording medium;

FIG. 2 schematically illustrates, in simplified cross-sectional view, a portion of a magnetic recording storage, and retrieval system comprised of a perpendicular magnetic recording medium and a single pole transducer head;

FIG. 3 schematically illustrates, in simplified cross-sectional view, a series of process steps according to an embodiment of the disclosed methodology;

FIG. 4 is a graph for illustrating the variation of ion penetration depth with variation of ion energy;

FIG. 5 illustrates various embodiments of the variation of ion energy in the disclosed method.

### DETAILED DESCRIPTION

The disclosed method addresses and solves problems, disadvantages, and drawbacks associated with the poor corrosion and environmental resistance of granular media fabricated according to prior methodologies, and is based upon recent investigations by the present inventors which have determined that the underlying cause of the poor corrosion performance of such media is attributable, inter alia, to incomplete surface coverage of the protective overcoat layer arising from increased nano-scale roughness of the granular layer relative to that of several other types of layers, the presence of porous grain boundaries, and/or poor adhesion of the protective overcoat layer at the grain boundaries.

The disclosed method is further based upon recognition by the present inventors that the aforementioned problems of poor corrosion and environmental resistance of granular layers can be mitigated, if not entirely eliminated, by performing a suitable treatment of the surface thereof prior to formation thereon of the protective overcoat layer. More specifically, the inventors have determined that the corrosion resistance of such media may be significantly improved by forming a thin, protective “cap” layer over the rough and porous surface of the granular layer upon completion of its formation, and then etching the surface of the cap layer to remove at least a portion of the thickness thereof and provide a relatively smooth, continuous surface for deposition of the protective overcoat layer thereon. Preferably, the etching process involves sputter etching with ions of an inert gas, e.g., Ar ions, for a sufficient interval to effect removal of at least a surface portion of the cap layer. An advantage afforded by provision of the cap layer according to the instant methodology vis-a-vis the previously disclosed methodology, is that the magnetic layer(s) underlying the cap layer are effectively shielded from etching, hence damage, by the ion bombardment sputter etching process, and disadvantageous alteration of the magnetic properties and characteristics of the as-deposited, optimized magnetic recording layer(s) is effectively eliminated while maintaining the improved corrosion resistance of the media provided by etching of the media surface prior to deposition of the protective overcoat layer.

According to a further embodiment of the present invention, an additional layer, i.e., a thin “etch-stop” layer comprised of a material which is more resistant to the particular etching process utilized, e.g., a thin layer of a sputter etch-resistant material, is provided between the as-deposited granular magnetic recording layer and the cap layer in order to minimize the likelihood of complete removal of the cap layer during the etching process disadvantageously resulting in etching of the granular layer and alteration of the properties and characteristics granular layer and granular media.

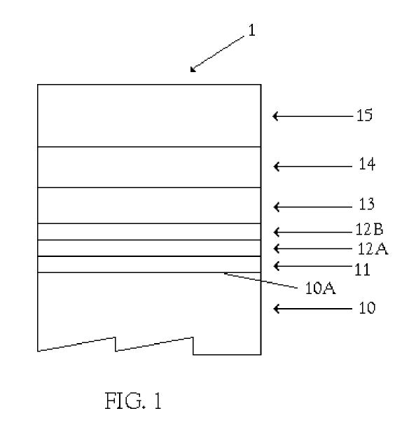

An exemplary embodiment of the present invention is described in the following with respect to magnetic recording media. A portion of a longitudinal recording, thin-film, hard disk-type magnetic recording medium 1 employed in computer-related applications is schematically illustrated in FIG. 1 in simplified cross-sectional view, and comprises a substantially rigid, metal substrate 10 which may be non-magnetic and is preferably of aluminum (Al) or an aluminum-based alloy, such as an aluminum-magnesium (Al—Mg) alloy, having sequentially deposited or otherwise formed on a surface 10A thereof a plating layer 11, such as of amorphous nickel-phosphorus (Ni—P); a seed layer 12A of an amorphous or fine-grained material, e.g., a nickel-aluminum (Ni—Al) or chromium-titanium (Cr—Ti) alloy; a polycrystalline underlayer 12B, preferably of Cr or a Cr-based alloy; a magnetic recording layer 13, e.g., of a cobalt (Co)-based alloy with one or more of platinum (Pt), Cr, boron (B), etc.; a protective overcoat layer 14, preferably containing carbon (C), e.g., DLC; and a lubricant topcoat layer 15, e.g., of a perfluoropolyether. Each of layers 11-14 may be deposited by suitable physical vapor deposition (“PVD”) techniques, such as sputtering, and layer 15 is preferably deposited by dipping or spraying.

In operation of medium 1, the magnetic layer 13 is locally magnetized by a write transducer, or write “head”, to record and thereby store data information therein. The write transducer or head creates a highly concentrated magnetic field which alternates direction based on the bits of information to be stored. When the local magnetic field produced by the write transducer is greater than the coercivity of the material of the recording medium layer 13, the grains of the polycrystalline material at that location are magnetized. The grains retain their magnetization after the magnetic field applied thereto by the write transducer is removed. The direction of the magnetization matches the direction of the applied magnetic field. The magnetization of the recording medium layer 13 can subsequently produce an electrical response in a read transducer, or read “head”, allowing the stored information to be read.

Efficient, high bit density recording utilizing a perpendicular magnetic medium requires interposition of a relatively thick (as compared with the magnetic recording layer), magnetically “soft” underlayer (“SUL”) layer, i.e., a magnetic layer having a relatively low coercivity below about 1 kOe, such as of a NiFe alloy (Permalloy), between the non-magnetic substrate, e.g., of glass, aluminum (Al) or an Al-based alloy, and the magnetically “hard” recording layer having relatively high coercivity, preferably about 3-8 kOe, e.g., of a cobalt-based alloy (e.g., a Co—Cr alloy such as CoCrPtB) having perpendicular anisotropy. The magnetically soft underlayer serves to guide magnetic flux emanating from the head through the hard, perpendicular magnetic recording layer.

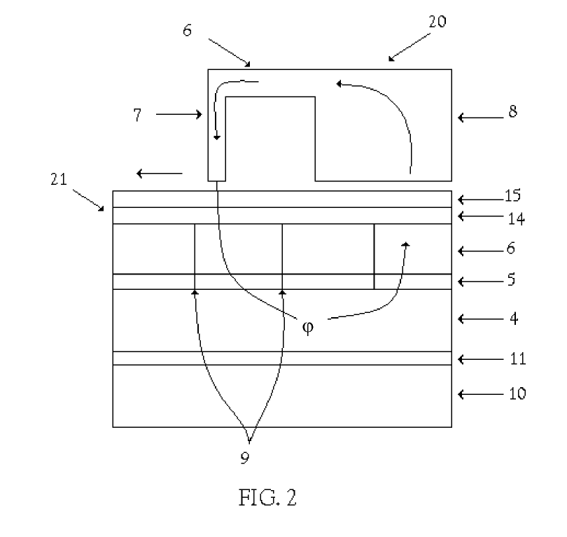

A perpendicular recording system 20 utilizing a vertically oriented magnetic medium 21 with a relatively thick soft magnetic underlayer, a relatively thin hard magnetic recording layer, and a single-pole head, is illustrated in FIG. 2, wherein reference numerals 10, 11, 4, 5, and 6, respectively, indicate a non-magnetic substrate, an adhesion layer (optional), a soft magnetic underlayer, at least one non-magnetic interlayer, and at least one perpendicular hard magnetic recording layer. Reference numerals 7 and 8, respectively, indicate the single and auxiliary poles of a single-pole magnetic transducer head 6. The relatively thin interlayer 5 (also referred to as an “intermediate” layer), comprised of one or more layers of non-magnetic materials, serves to (1) prevent magnetic interaction between the soft underlayer 4 and the at least one hard recording layer 6 and (2) promote desired microstructural and magnetic properties of the at least one hard recording layer.

As shown by the arrows in the figure indicating the path of the magnetic flux φ, flux φ is seen as emanating from single pole 7 of single-pole magnetic transducer head 6, entering and passing through the at least one vertically oriented, hard magnetic recording layer 5 in the region below single pole 7, entering and traveling within soft magnetic underlayer 3 for a distance, and then exiting therefrom and passing through the at least one perpendicular hard magnetic recording layer 6 in the region below auxiliary pole 8 of single-pole magnetic transducer head 6. The direction of movement of perpendicular magnetic medium 21 past transducer head 6 is indicated in the figure by the arrow above medium 21.

With continued reference to FIG. 2, vertical lines 9 indicate grain boundaries of polycrystalline layers 5 and 6 of the layer stack constituting medium 21. Magnetically hard main recording layer 6 is formed on interlayer 5, and while the grains of each polycrystalline layer may be of differing widths (as measured in a horizontal direction) represented by a grain size distribution, they are generally in vertical registry (i.e., vertically “correlated” or aligned).

Completing the layer stack is a protective overcoat layer 14, such as of a diamond-like carbon (DLC), formed over hard magnetic layer 6, and a lubricant topcoat layer 15, such as of a perfluoropolyethylene material, formed over the protective overcoat layer.

Substrate 10 is preferably disk-shaped and comprised of a non-magnetic metal or alloy, e.g., Al or an Al-based alloy, such as Al—Mg having an Ni—P plating layer on the deposition surface thereof or substrate 10 is comprised of a suitable glass, ceramic, glass-ceramic, polymeric material, or a composite or laminate of these materials. Optional adhesion layer 11, if present, may comprise an up to about 30 Å thick layer of a material such as Ti or a Ti alloy. Soft magnetic underlayer 4 is preferably comprised of an about 500 to about 4,000 Å thick layer of a soft magnetic material selected from the group consisting of Ni, NiFe (Permalloy), Co, CoZr, CoZrCr, CoZrNb, CoFeZrNb, CoFe, Fe, FeN, FeSiAI, FeSiAlN, FeCoB, FeCoC, etc. Interlayer 5 preferably comprises an up to about 300 Å thick layer or layers of non-magnetic material(s), such as Ru, TiCr, Ru/CoCr RuCr/CoCrPt, etc.; and the at least one hard magnetic layer 6 is preferably comprised of an about 100 to about 250 Å thick layer(s) of Co-based alloy(s) including one or more elements selected from the group consisting of Cr, Fe, Ta, Ni, Mo, Pt, V, Nb, Ge, B, and Pd, iron nitrides or oxides, or a (CoXPd or Pt)ₙ multilayer magnetic superlattice structure, where n is an integer from about 10 to about 25. Each of the alternating, thin layers of Co-based magnetic alloy of the superlattice is from about 2 to about 3.5 Å thick, X is an element selected from the group consisting of Cr, Ta, B, Mo, Pt, W, and Fe, and each of the alternating thin, non-magnetic layers of Pd or Pt is up to about 10 Å thick. Each type of hard magnetic recording layer material has perpendicular anisotropy arising from magneto-crystalline anisotropy (1^{st} type) and/or interfacial anisotropy (2^{nd} type).

A way of classifying magnetic recording media is on the basis by which the magnetic grains of the recording layer are mutually separated, i.e., segregated, in order to physically and magnetically de-couple the grains and provide improved media performance characteristics. According to this classification scheme, magnetic media with Co-based alloy magnetic recording layers (e.g., CoCr alloys) are classified into two distinct types: (1) a first type, wherein segregation of the grains occurs by diffusion of Cr atoms of the magnetic layer to the grain boundaries of the layer to form Cr-rich grain boundaries, which diffusion process requires heating of the media substrate during formation (deposition) of the magnetic layer; and (2) a second type, wherein segregation of the grains occurs by formation of oxides, nitrides, and/or carbides at the boundaries between adjacent magnetic grains to form so-called “granular” media. For example oxides, nitrides, and/or carbides may be formed by introducing a minor amount of at least one reactive gas containing oxygen, nitrogen, and/or carbon atoms (e.g. 0₂, N₂, CO₂ etc.) to an inert gas (e.g., Ar) atmosphere during sputter deposition of the Co alloy-based magnetic layer, the oxides, nitrides and/or carbides may also be formed by other methods.

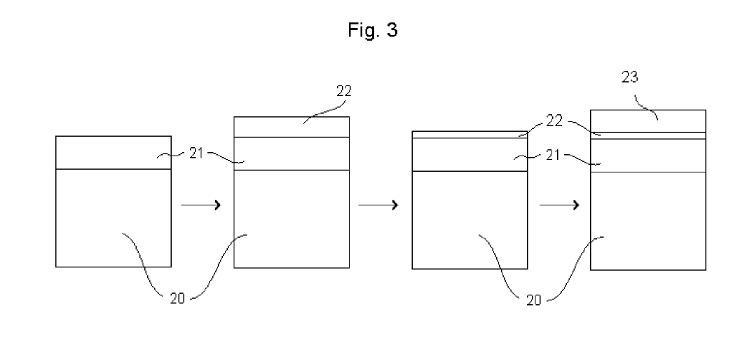

Referring now to FIG. 3, a series of process steps embodying the principles of the disclosure will now further be described in detail by reference to the following illustrative, but not limitative, example of the instantly disclosed methodology. According to an initial step of the methodology, a magnetic recording medium with a layer stack similar to that shown in FIG. 1 and described supra is provided, and preferably includes a disk-shaped non-magnetic substrate 20 comprised of a non-magnetic material selected from the group consisting of: Al, NiP-plated Al, Al—Mg alloys, other Al-based alloys, other non-magnetic metals, other non-magnetic alloys, glass, ceramics, polymers, glass-ceramics, and composites and/or laminates of the aforementioned materials and a layer stack 21 formed thereon which includes an outermost granular longitudinal or perpendicular magnetic recording film or layer. The latter is illustratively (but not limitatively) comprised of a CoPtX alloy, where X=at least one element or material selected from the group consisting of: Cr, Ta, B, Mo, V, Nb, W, Zr, Re, Ru, Cu, Ag, Hf, Ir, Y, O, Si, Ti, N, P, Ni, SiO, Si Al, A1N, TiO, TiN, TiC, Ta, NiO, and CoO, and wherein Co-containing magnetic grains are segregated by grain boundaries comprising at least one of oxides, nitrides, and carbides formed e.g., by reactive sputtering.

Still referring to FIG. 3, in the next step according to the methodology, a thin cap layer 22 is formed over the exposed uppermost surface of the granular magnetic recording layer 21 by any convenient thin film deposition technique, e.g., sputtering. According to the disclosure, the cap layer preferably is comprised of a metallic material, i.e., an amorphous or crystalline metallic layer of thickness from about 5 Å to about 100 Å, and may be formed of a single metal element or a multi-element alloy. Suitable elemental and alloy materials for use as the cap layer according to the disclosure include those selected from the group consisting of: Cr-containing alloys, Ta-containing alloys, and Nb-containing alloys. In one example, the cap layer is formed of CrTa.

In the next step according to the disclosure, illustrated in FIG. 3, the cap layer is subjected to an etching process for removing at least a portion of the thickness thereof. Suitable etching techniques for controllable removal of a desired thickness of the cap layer include ion etching, such as sputter etching with ions of an inert gas (e.g., Ar ions). According to the methodology, a portion of the thickness of the cap layer 22 may remain after ion etching or the entire thickness thereof may be removed. Thus, the thickness of the cap layer 22 after ion etching may range from about 0 to about 50 Å.

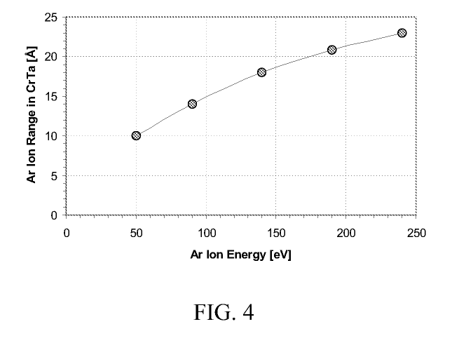

Ion etching successfully removes the cap layer progressively at a rate that is dependent upon ion energy. Higher ion energy causes the cap layer 22 to etch more quickly. Faster etching rates are more desirable because it increases productivity, thereby reducing costs. However, in addition to yielding higher etch rates, higher ion energy also increases the depth at which the etching ions penetrate into the etched surface. The relationship between ion energy and ion penetration depth is illustrated in FIG. 4, which relates to one embodiment of the disclosed method.

The correlation shown in FIG. 4 relates to a cap layer formed of CrTa and Ar ion sputter etching. The plot shows that increased ion energy will result in the Ar ions penetrating deeper into the layer. If the ion penetration depth is greater than the thickness of the cap layer 22, the etching ions may penetrate into the magnetic film layer. This bombardment of sputtering ions into the magnetic layer degrades the magnetic properties of the media. For example, magnetic thickness Mrt and coercivity Hc will drop as the cap layer is etched, if the ion penetration depth is greater than the cap layer thickness.

To avoid degradation of the magnetic properties of the media, the cap layer should be etched with ions having ion energies corresponding to penetration depths in the material of the cap layer 22 that are smaller than the thickness of the cap layer 22. On the other hand, it is desirable that the cap layer 22 be etched to a small thickness to keep the HMS at a minimum, where HMS is the distance between the head and the media. At such a small thickness, the ion energy of the etching ions should be small in order to avoid degrading the magnetic properties of the magnetic layer. However, if the entire cap layer is etched with small ion energy, productivity will slow considerably, raising costs.

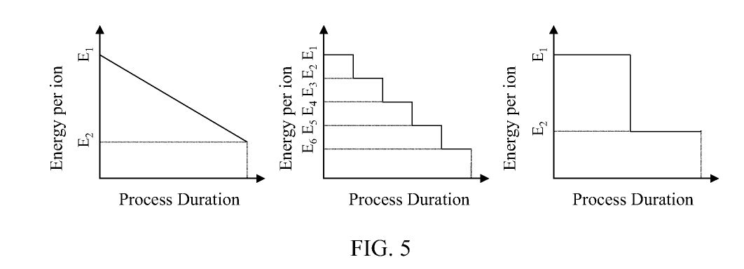

Accordingly, the disclosed method includes etching the cap layer with a first ion energy when the thickness of the cap layer is high. The ion energy may then be lowered to a second ion energy when the cap layer is thinner. Different embodiments of the change in ion energy during etching is shown in FIG. 5. The ion energy may be continuously ramped down from the first ion energy to the second ion energy over time. Alternatively, the ion energy may be decreased in steps. For example, the cap layer may be etched for a first duration of time at the first higher ion energy and then the ion energy may be stepped down to the second ion energy and the layer etched for a second duration of time. If desired, the ion energy may be decreased over a plurality of steps. Each of the steps can last for the same duration of time, or they may last differing durations of time. In one embodiment of the method, the ion energy used during etching corresponds to an ion penetration depth at or below the thickness of the cap layer. Accordingly, the magnetic properties of the magnetic layer are not degraded. Thus, if Ar is used as the ion for ion etching the cap layer, the magnetic layer is free of sputtered Ar atoms.

With additional reference to FIG. 3, following etching, another step according to the disclosure, is forming a protective overcoat layer 23, preferably a carbon (C)-containing protective overcoat layer, on the exposed surface of the remaining cap layer or on the exposed surface of the granular magnetic recording layer, as by any suitable technique. Preferably, the protective overcoat layer comprises an about 15 to about 50 Å thick layer of DLC formed by means of ion beam deposition (IBD), plasma-enhanced chemical vapor deposition (PECVD), or filtered cathodic arc deposition (filtered CAD).

It should be noted that the above-described embodiments of the instantly disclosed methodology are merely illustrative, and not limitative, of the advantageous results afforded by the invention. Specifically, the methodology is not limited to use with the illustrated CoPtX magnetic alloys, but rather is useful in providing enhanced corrosion and environmental resistance of granular media with layers having surfaces with nano-scale roughness and porosity, for example, a sputtered material with granular layers. Similarly, the ion etching treatment of the disclosure is not limited to use with the illustrated Ar ions, and satisfactory ion etching may be performed with numerous other inert ion species, including, for example, He, Kr, Xe, and Ne ions. In addition, specific process condition for performing the ion etching are readily determined for use in a particular application of the disclosed methodology, including selection of the rate of flow of the inert gas, substrate bias voltage, ion etching interval, ion energy, and etching rate. For example, suitable ranges of substrate bias voltages, ion energies, and etching rates are 0-300 V, 10-400 eV, and 0.1-20 Å/sec., respectively. Lastly, the protective overcoat layer is not limited to IBD and DLC but rather all manner of protective overcoat materials and deposition methods therefore may be utilized.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein. The implementations described above and other implementations are within the scope of the following claims.

What is claimed is:

1. A method of manufacturing granular media, comprising:
providing a substrate, a layer stack disposed on the substrate, the layer stack including an outermost granular layer, a cap layer disposed on the granular layer, said cap layer having an outer surface; and
ion etching the outer surface of said cap layer to remove at least a portion of the thickness thereof, the etching being carried out at a set ion energy over a duration of time, the set ion energy including a first ion energy followed by a lower second ion energy.

2. The method according to claim 1, wherein:
the media comprises a magnetic recording media and the layer stack includes an outermost longitudinal or perpendicular recording layer.

3. The method according to claim 1, wherein the cap material is comprised of a material selected from the group consisting of: Cr-containing alloys, Ta-containing alloys, and Nb-containing alloys.

4. The method according to claim 1, wherein the ion etching comprises sputter etching.

5. The method according to claim 1, wherein the ion etching comprises sputter etching of ions of an inert gas.

6. The method according to claim 5, wherein the inert gas is Ar.

7. The method according to claim 1, wherein the set ion energy is ramped from the first ion energy to the second ion energy.

8. The method according to claim 1, wherein the set ion energy is stepped from the first ion energy to the second ion energy.

9. The method according to claim 8, wherein the set ion energy is stepped to at least one intermediate ion energy between the first and second ion energies.

10. The method according to claim 8, wherein the steps are of equal duration.

11. The method according to claim 8, wherein the steps are of differing duration.

12. The method according to claim 1, wherein the set ion energy corresponds to a penetration depth that is lower than a thickness of the cap layer.

13. The method according to claim 1, wherein the cap layer is etched to a thickness that is no less than an ion penetration depth corresponding to the set ion energy.

14. A granular magnetic recording medium, comprising:
(a) a non-magnetic substrate having a surface;
(b) a layer stack on said surface, said layer stack including an outermost granular magnetic recording layer substantially free of Ar etching atoms;
(c) a cap layer on said granular magnetic recording layer, said cap layer having a sputter-etched outer surface; and
(d) a protective overcoat layer on said sputter-etched outer surface of said cap layer.

15. The medium as in claim 14, wherein:
said granular magnetic recording layer is a perpendicular or longitudinal magnetic recording layer.

16. The medium as in claim 14, wherein:
said cap layer includes an amorphous or crystalline metallic layer comprised of a material selected from the group consisting of: Cr-containing alloys, Ta-containing alloys, and Nb-containing alloys.

17. The medium as in claim 14, wherein said granular magnetic recording layer comprises Co-containing magnetic grains comprising a CoPtX alloy, where X is at least one element or material selected from the group consisting of: Cr, Ta, B, Mo, V, Nb, W, Zr, Re, Ru, Cu, Ag, Hf, Ir, Y, O, Si, Ti, N, P, Ni, SiO, Si Al, AlN, TiO, TiN, TiC, Ta, NiO, and CoO, and wherein the Co-containing magnetic grains are segregated by grain boundaries comprising at least one of oxides, nitrides, and carbides.

18. The medium as in claim 14, wherein:
said protective overcoat layer comprises a carbon (C)-containing material.
